(19) United States
(12) Patent Application Publication
(10) Pub. No.: US 2026/0094863 A1
(43) Pub. Date: Apr. 2, 2026

(54) METHOD FOR PREPARING ELECTROLYTE AND ELECTROLYTE PREPARED THEREBY

(71) Applicant: LG ENERGY SOLUTION, LTD., Seoul (KR)

(72) Inventors: Sung Hyun NAM, Daejeon (KR); Hyea Eun HAN, Daejeon (KR); Dong Kyu KIM, Daejeon (KR)

(21) Appl. No.: 19/112,090

(22) PCT Filed: Oct. 13, 2023
(86) PCT No.: PCT/KR2023/015789

§ 371 Date: Mar. 14, 2025

(30) Foreign Application Priority Data
Oct. 14, 2022 (KR) 10-2022-0132766
Oct. 12, 2023 (KR) 10-2023-0136063

(51) Int. Cl. H01M 10/056

(52) U.S. Cl. CPC H01M 10/056; H01M 2300/0068; H01M 2300/0082; H01M 2300/0091; H01M 2300/0094

(57) ABSTRACT

A method for preparing an electrolyte and an electrolyte prepared by the preparation method are provided. The preparation method includes the steps of: (S1) preparing a solution comprising a polyethylene oxide(PEO)-based copolymer having crosslinkable functional groups and a ceramic compound; (S2) supplying a substrate to a transfer path by unwinding the substrate using an unwinder; (S3) forming a coating film by coating the solution on the substrate; (S4) forming a polymer film by transferring the substrate having the coating film formed thereon to a drying section and drying the same; (S5) forming an electrolyte layer by transferring the substrate having the polymer film to a vapor deposition section and vapor-depositing a polar compound on the polymer film; and (S6) winding and recovering the substrate including the electrolyte layer using a rewinder.

### CROSS CITATION WITH RELATED APPLICATION(S)

This application is a National Phase entry pursuant to 35 U.S.C. § 371 of International Application No. PCT/KR2023/015789 filed on Oct. 13, 2023, and claims priority to and the benefit of Korean Patent Application No. 10-2022-0132766 filed on Oct. 14, 2022 and Korean Patent Application No. 10-2023-0136063 filed on Oct. 12, 2023, the disclosures of which are incorporated herein by reference in their entirety.

### FIELD

The present disclosure relates to a method for preparing an electrolyte and an electrolyte prepared thereby.

### BACKGROUND

A lithium ion battery using a liquid electrolyte has a structure in which a negative electrode and a positive electrode are defined by a separator, and thus may cause a short-circuit when the separator is damaged by deformation or external impact, resulting in a risk, such as overheating or explosion. Therefore, it can be said that development of a solid electrolyte capable of ensuring safety is a very important issue in the field of lithium ion secondary batteries.

A lithium secondary battery using a solid electrolyte is advantageous in that it is enhanced in safety, prevents leakage of an electrolyte to improve the reliability of a battery, and facilitates manufacture of a thin battery. In addition, lithium metal can be used as a negative electrode to improve energy density, and therefore, it has been expected to be applied to a high-capacity secondary battery for electric vehicles in addition to a compact secondary battery, and thus has been spotlighted as a next-generation battery.

Among solid electrolytes, a polymer solid electrolyte may include a polymeric material made of an ion conductive material, or an inorganic material such as oxides or sulfides having ion-conducting properties. In addition, a composite polymer solid electrolyte which is a mixture of polymer materials and inorganic materials has been proposed.

Such a conventional composite polymer solid electrolyte is prepared by dispersing oxide-based ceramic powder, etc. in a polymer matrix, and has the advantage of having higher stability than existing liquid electrolytes and higher ionic conductivity than a polymer solid electrolyte, but has the difficulty of meeting basic prerequisites, such as improving the dispersibility of ceramic particles such as oxides in a polymer matrix and optimizing the physical properties of the polymer matrix used. In particular, there are limitations in that it is difficult to prepare a composite solid electrolyte with improved ionic conductivity using a highly crystalline polymer such as polyethylene oxide (PEO). In other words, the high crystallinity of the polymer impedes the chain mobility of the polymer chain, and thus, the movement of lithium ions within the polymer solid electrolyte is limited, which made it difficult to improve the ionic conductivity of the polymer solid electrolyte.

In order to overcome such limitations of the conventional composite solid electrolyte, a technology has been developed to modify the structure of the crystalline polymer or add a separate plasticizer to the polymer to thereby improve the mobility of the polymer chain and enhance the ionic conductivity of the composite solid electrolyte. However, the solid polymer electrolyte prepared by using such structural deformation of polymers and addition of plasticizers has difficulty in improving the ionic conductivity to a level of 1 mS/cm or higher.

Therefore, in addition to the polymer solid electrolyte prepared by modifying the structure of the polymer, adding a separate plasticizer, or immersing the solid electrolyte in the liquid electrolyte, there is a need to develop a technology relating to a method for preparing an electrolyte, which can improve the ionic conductivity of the electrolyte and enables a continuous process, as a pure solid electrolyte for all-solid-state battery.

### RELATED ART

Japanese Unexamined Patent Publication No. 1994-124713

### SUMMARY

### Technical Problem

It is an object of the present disclosure to provide a method for preparing an electrolyte that improves ionic conductivity and enables a continuous process, and an electrolyte prepared thereby.

### Technical Solution

According to one embodiment of the present disclosure, there is provided a method for preparing an electrolyte, the method comprising: (S1) preparing a solution comprising a polyethylene oxide(PEO)-based copolymer having crosslinkable functional groups and a ceramic compound; (S2) supplying a substrate to a transfer path by unwinding the same using an unwinder; (S3) forming a coating film by coating the solution on the substrate; (S4) forming a polymer film by transferring the substrate having the coating film formed thereon to a drying section and drying the same; (S5) forming an electrolyte layer by transferring the substrate having the polymer film to a vapor deposition section and vapor-depositing a polar compound on the polymer film; and (S6) winding and recovering the substrate including the electrolyte layer formed thereon using a rewinder.

In the preparation method, the solution of the step (S1) may further comprise one or more selected from the group consisting of a lithium salt, a crosslinking agent, and an initiator. Such a solution may contain 10 to 100 parts by weight, or 10 to 60 parts by weight of the ceramic compound based on 100 parts by weight of the PEO-based copolymer.

In the vapor-depositing of the step (S5), the polar compound is evaporated at room temperature or evaporated by heating such that gas molecules of the polar compound are bonded to a surface of or dispersed between polymer chains of the PEO-based copolymer.

Meanwhile, in the preparation method, the crosslinkable functional groups are bonded to a main chain of the PEO-based copolymer via a direct bond or a linker having 0 to 10 carbon atoms, and may be selected from the group consisting of a hydroxyl group, a carboxyl group, an isocyanate group, a nitro group, a cyano group, an amine group, an amide group, an epoxy group and an allyl group.

In a more specific example, the PEO-based copolymer may comprise repeating units of the following Chemical Formulas 1 to 3:

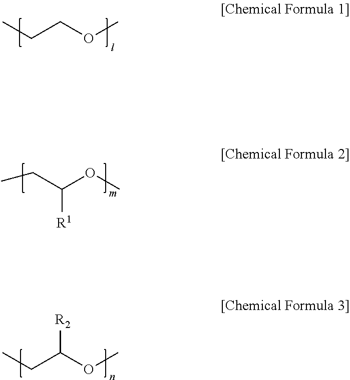

wherein, in Chemical Formulas 1 to 3, R₁ is —CH₂—O—(CH₂—CH₂—O)ₖ—R₃, k is 0 to 20, R₃ is an alkyl group having 1 to 5 carbon atoms,
R₂ is a group in which one or more crosslinkable functional groups selected from the group consisting of a hydroxyl group, a carboxyl group, an isocyanate group, a nitro group, a cyano group, an amine group, an amide group, an epoxy group and an allyl group are bonded to a main chain of the PEO-based copolymer via a direct bond or a linker having 0 to 10 carbon atoms, and
l, m and n are the number of repetitions of the repeating unit, wherein l and n are each independently an integer of 1 to 1000, and m is an integer of 0 to 1000.

Further, in the preparation method, an electrolyte may be prepared in which a content of the polar compound is 0.1% by weight or more and less than 10% by weight based on the total weight of the electrolyte.

At this time, the polar compound may comprise at least one selected from the group consisting of a carbonate-based compound and a sulfonyl-based compound. More specifically, the polar compound may comprise at least one selected from the group consisting of ethyl methyl carbonate(EMC), dimethyl carbonate(DMC), diethyl carbonate(DEC), ethylene carbonate(EC), propylene carbonate(PC), vinylene carbonate(VC) and Sulfolane.

Meanwhile, the ceramic compound may comprise at least one selected from the group consisting of a lithium-lanthanum-zirconium oxide(LLZO)-based compound, a lithium-silicon-titanium phosphate(LSTP)-based compound, a lithium-lanthanum-titanium oxide(LLTO)-based compound, a lithium-aluminum-titanium phosphate(LATP)-based compound, a lithium-aluminum-germanium phosphate(LAGP)-based compound, and a lithium-lanthanum-zirconium-titanium oxide(LLZTO)-based compound.

Further, in the preparation method, the steps (S1) to (S6) may be performed continuously.

Meanwhile, according to another embodiment of the present disclosure, there is provided an electrolyte prepared by the method of the above-mentioned one embodiment. Such an electrolyte comprises a polymer containing a PEO-based copolymer containing a crosslinkable functional group; a ceramic compound; and a polar compound, wherein at a part of the crosslinkable functional group form a crosslinking bond with each other, so that the polymer forms a three-dimensional network structure, and wherein the polar compound in a gaseous state is contained in the three-dimensional network structure or may have a structure bonded to the polymer chain.

### Advantageous Effects

The method for preparing an electrolyte according to the present disclosure can prepare an electrolyte by a continuous process, and is being capable of being mass-produced.

In addition, the electrolyte can maintain the original structural characteristics of the polymer without deforming or destructing the polymer chain, improve the mobility of the polymer chain and uniformly distribute the ceramic particles in the electrolyte, thereby increasing the ionic conductivity of the electrolyte.

Further, the electrolyte contains a very small amount of a polar compound in a gaseous state, and thus can exhibit improved ionic conductivity and mechanical properties.

### BRIEF DESCRIPTION OF THE DRAWINGS

FIG. 1 is a flow chart of the method for preparing an electrolyte of the present disclosure.

### DETAILED DESCRIPTION

Hereinafter, specific embodiments will be described in more detail for a better understanding of the present disclosure.

Terms or words used in the specification and the appended claims should not be construed as limited to ordinary or dictionary meanings, and the present disclosure should be construed with meanings and concepts that are consistent with the technical idea of the present disclosure based on the principle that the inventors may appropriately define concepts of the terms to appropriately describe their own invention in the best way.

The term “polymer film” as used herein refers to a film which is prepared by coating and drying a mixed solution containing a PEO (polyethylene oxide)-based copolymer containing a crosslinkable functional group and a ceramic compound. A polymer chain containing a crosslinking bond by the crosslinkable functional group is formed in the inside of the polymer film, and the internal space of the polymer chain contains a ceramic compound in a dispersed form.

The term “electrolyte” as used herein refers to an electrolyte having a structure in which the polymer film is vapor-deposited with a polar compound such that the polar compound is bonded to the surface of or the polymer chains or d of the polymer chain.

With regard to the term “bond” as used herein, that is, the conformation in which a polar compound is “bonded” to a polymer chain, e.g., a chain of a PEO-based copolymer, the term “bond” broadly refers to a conformation in which a polar compound in a gaseous state is maintained in a state fixed to a polymer chain by vapor-deposition of the polar compound. In other words, the “bond” is not limited to a specific type of physical bond, chemical bond, etc., and means including a state fixed by various bonds, including physical bonds, chemical bonds, etc., or a state simply attached and fixed, such as by adsorption, etc., or a state that is included in a three-dimensional network structure formed by crosslinking of the polymer, and is located and fixed adjacent to a polymer chain or crosslinking structure.

The term “three-dimensional network structure” as used herein is a structure that includes a three-dimensional frame and an internal space defined by the frame, wherein the frame may include a polymer chain that includes a crosslinking bond formed by the crosslinkable functional groups, e.g., a crosslinking bond between the crosslinkable functional groups and/or a crosslinking bond between the crosslinkable functional groups and a crosslinking agent. The three-dimensional network structure may also be referred to as a crosslinked structure.

In the present disclosure, the presence or inclusion of a polar compound in an electrolyte in a “gaseous state” indicates that the polar compound is deposited in a vapor state, unlike the case where the polar compound or the electrolyte containing the same is injected in a liquid state, and the polar compound exists in a state distinct from the liquid injected electrolyte immediately after preparing the electrolyte or during the charging and discharging process of an all-solid-state secondary battery containing the same. However, depending on the storage or operating conditions of the electrolyte and/or secondary battery, the vapor-deposited polar compound may have a locally or temporarily liquefied state. Even in such a case, the vapor-deposited polar compound exhibits a higher mobility than the polar compound injected in a liquid state, and exhibits a state different from the polar compound in a liquid state, which can also be considered to exist or be included in the “gaseous state” mentioned above.

On the other hand, conventionally, in order to improve the ionic conductivity of the solid electrolyte, a composite solid electrolyte was prepared in which ceramic compounds such as oxides were dispersed in a polymer matrix, however, such a composite solid electrolyte has a problem of reducing the ionic conductivity when the oxide-based ceramic particles in the polymer matrix are ununiformly distributed or when a highly crystalline polymer such as polyethylene oxide is used as the polymer.

Further, conventionally, in order to improve the ionic conductivity of the solid electrolyte, a solid electrolyte was immersed in or supported on a liquid electrolyte or a solvent (polar compound in liquid state), or the liquid electrolyte or the solvent was directly injected into the solid electrolyte in a liquid state. When a liquid electrolyte or solvent is added directly to the solid electrolyte in this way, it has the effect of improving the ionic conductivity of the solid electrolyte, but this is merely an effect of increasing the ionic conductivity of the solid electrolyte based on the high ionic conductivity of the liquid itself, and the degree of improvement thereof is also not sufficient, and it is necessary to inject a considerable amount of liquid electrolyte. In other words, since the conduction of lithium ions is achieved by the liquid electrolyte added to the solid electrolyte rather than the inherent physical properties of the solid electrolyte, it is far from improving the physical properties of the solid electrolyte itself. Further, when a liquid electrolyte or solvent was added directly into a solid electrolyte in liquid form, there was a problem that the structure of the solid electrolyte collapsed due to unexpected side reactions between the polymer and the liquid phase, such as damage to the polymer chain or breaking of bonds within the polymer, or a decrease in ionic conductivity resulting therefrom.

Further, when solvent or liquid electrolyte is directly injected into the solid electrolyte, liquid molecules rapidly diffuse within the solid electrolyte to rapidly cause a relaxation phenomenon of the polymer chain and promote gelation on the surface, which may lead to a decrease in mechanical properties, and problems such as liquid leakage may not be completely resolved.

In addition, Japanese Unexamined Patent Publication No. 1994-124713, which is a prior art, discloses a technology for vapor-depositing a solvent on a general PEO (polyethylene oxide) polymer. In this case, there was a problem that the internal structure of the polymer was collapsed and the ionic conductivity could not be ensured.

Thus, the present inventors have prepared a polymer film which is crosslinked with a PEO (polyethylene oxide)-based copolymer modified with a crosslinkable functional group, wherein during crosslinking, the ceramic compounds are mixed together to ensure that the ceramic compounds are uniformly dispersed in the internal space of the polymer chain. Further, by bringing the polymer film into contact with a vapor of the polar compound, a very small amount of gas molecules of the polar compound are boned to the polymer chain or included in the internal space of the polymer chain.

The electrolyte prepared in this way comprises a polymer containing a PEO (polyethylene oxide)-based copolymer containing a crosslinkable functional group; a ceramic compound; and a polar compound, wherein at least a part of the crosslinkable functional groups form a crosslinking bond with each other, so that the polymer forms a three-dimensional network structure, and wherein the polar compound in a gaseous state is contained in the three-dimensional network structure or can represent a structure bonded on a polymeric chain.

It was confirmed that this electrolyte exhibits improved ionic conductivity even while containing a trace amount of a polar compound in a gaseous state. This is predicted to be because the polar compound in a gaseous state affect the physical properties such as crystallinity of the PEO-based copolymer, and increases the chain mobility of the polymer chain, thereby improving the conductivity of lithium ions contained in the electrolyte. In addition, such an ionic conductivity can be further improved by uniform dispersion of the ceramic compound.

Furthermore, the present inventors have developed a method for preparing an electrolyte which can prepare an electrolyte showing improved ionic conductivity through a continuous process using the above-mentioned principle, so that its mass production is made possible.

Next, such a method for preparing an electrolyte will be described in detail.

### Method for Preparing Electrolyte

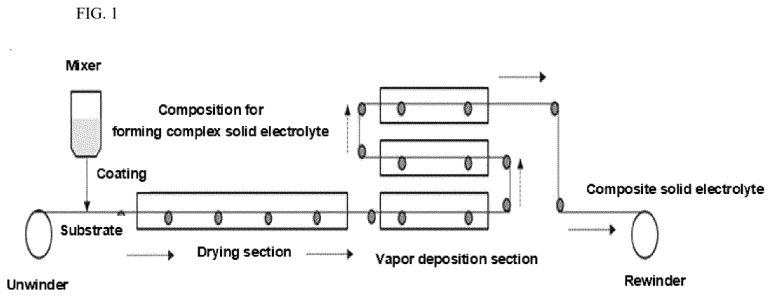

According to one embodiment of the disclosure, there is provided a method for preparing an electrolyte, and an example of a flow chart thereof is shown in FIG. 1.

Referring to FIG. 1, the method for preparing the electrolyte of one embodiment comprises the steps of: (S1) preparing a mixed solution containing a PEO (polyethylene oxide)-based copolymer containing a crosslinkable functional group and a ceramic compound; (S2) unwinding a substrate using an unwinder and supplying it to a transfer path; (S3) coating the mixed solution onto the substrate to form a coating film; (S4) transferring the substrate having the coating film formed thereon to a drying section and drying it to form a polymer film; (S5) transferring the polymer film to a vapor deposition section and vapor-depositing a polar compound to form an electrolyte layer; and (S6) winding and recovering the substrate including the electrolyte layer using a rewinder. At this time, steps (S1) to (S6) may be performed continuously.

Below, the preparation method of one embodiment will be described in more detail for each step.

In step (S1), a mixed solution containing a PEO (polyethylene oxide)-based copolymer containing a crosslinkable functional group and a ceramic compound can be prepared.

The mixed solution can be prepared by mixing the PEO-based copolymer and a ceramic compound in a solvent, and may be further prepared when mixing any one or more of a lithium salt, a crosslinking agent, and an initiator. An electrolyte can be formed by mixing the lithium salt, and a crosslinking bond of the PEO-based copolymer can be formed when mixing a crosslinking agent and/or an initiator.

The solvent is not particularly limited as long as it is a solvent that can be mixed and dissolved with the PEO-based copolymer and any one or more of a lithium salt, a crosslinking agent and an initiator, and can be easily removed by a drying process. For example, the solvent may be acetonitrile, methanol, ethanol, tetrahydrofuran, water, isopropyl alcohol, dimethyl sulfoxide(DMSO), N-methyl-2-pyrrolidone(NMP), N,N-dimethyl formamide(DMF) or the like. Such a solvent is a solvent that serves as a reaction medium for forming a crosslinking bond, and is distinguished from polar solvents contained in liquid electrolytes, and the like, and is completely removed by drying or the like after crosslinking.

The concentration of the mixed solution can be appropriately adjusted in consideration of the extent to which the molding process for preparing the electrolyte can proceed smoothly. Specifically, the concentration of the mixed solution may mean the concentration (w/w %) of the polymer in the mixed solution. At this time, the concentration of the polymer may be the concentration of the PEO-based copolymer. For example, the concentration of the mixed solution may be 5% by weight to 20% by weight, and specifically, it may be 5% by weight or more, 7% by weight or more, or 9% by weight or more, and 13% by weight or less, 17% by weight or less, or 20% by weight or less. If the concentration of the mixed solution is less than 5% by weight, the concentration may be too diluted, and the mechanical strength of the electrolyte may decrease, or it may flow down when coated onto a substrate. If the concentration is more than 20% by weight, it will be difficult to dissolve the lithium salt at the desired concentration in the mixed solution, the viscosity will be high, and the solubility will be reduced, or it may be difficult to coat the lithium salt in the form of a uniform thin film.

Further, the crosslinkable functional group may be composed of two or more types. The crosslinkable functional groups may be the same or different from each other, and preferably may be different. When the crosslinkable functional groups are different, multiple types of repeating units each containing these functional groups may be included. Further, when multiple types of crosslinkable functional groups are included, it may become easier to control the mobility and ionic conductivity of the polymer chain.

The crosslinkable functional group refers to a functional group capable of forming a crosslinking bond between crosslinkable functional groups and/or of forming a crosslinking bond with each other through a crosslinking agent, and can be bonded with the main chain of the polymer chain in the form of a side chain.

Specifically, the crosslinkable functional group may be directly bonded to the main chain or the like of the PEO-based copolymer, or may be bonded through an alkylene or alkylene oxide linker. Thus, the crosslinkable functional group may be bonded through an alkylene linker or alkylene oxide linker having 0 to 10 carbon atoms (provided that an alkylene linker having 0 carbon atoms represents a single bond), and may be at least one selected from the group consisting of a hydroxyl group, a carboxyl group, an isocyanate group, a nitro group, a cyano group, an amine group, an amide group, an epoxy group and an allyl group.

In a more specific example, the PEO-based copolymer containing the crosslinkable functional group may be a copolymer containing repeating units of the following Chemical Formulas 1 to 3:

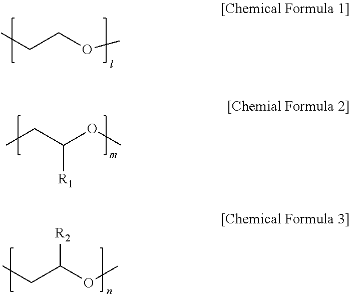

wherein, in Chemical Formulas 1 to 3, R₁ represents —CH₂—O—(CH₂—CH₂—O)ₖ—R₃, k is 0 to 20, R₃ represents an alkyl group having 1 to 5 carbon atoms,
R₂ represents a substituent in which one or more crosslinkable functional groups selected from the group consisting of a hydroxyl group, a carboxyl group, an isocyanate group, a nitro group, a cyano group, an amine group, an amide group, an epoxy group and an allyl group are bonded to a polymer chain via an alkylene linker or alkylene oxide linker having 0 to 10 carbon atoms (provided that an alkylene linker having 0 carbon atoms represents a single bond), and
l, m and n are the number of repetitions of the repeating unit, wherein l and n are each independently an integer of 1 to 1000, and m is an integer of 0 to 1000.

For example, the crosslinkable functional group of R₂ can form a polymer having a matrix form of a three-dimensional network structure formed by the crosslinking bond. By forming a three-dimensional network structure by the crosslinking bond, the mechanical properties of the electrolyte can be improved, and a polar compound in a gaseous state may be included or bonded within such a three-dimensional network structure to provide an electrolyte having improved ionic conductivity.

Further, it is obvious that the PEO-based copolymer may include two or more types of repeating units of Chemical Formula 3 in which the R₂ is crosslinkable functional groups different from each other, and may also include one or more types of repeating units of Chemical Formula 2.

When l, m and n are each less than 1, it is difficult to form a polymer because the molecular weight is small, and when l, m and n are each more than 1000, the solubility during preparation of a polymer solution decreases due to an increase in viscosity, and molding for preparing a solid electrolyte may become difficult. In particular, when the number of repetitions of the repeating unit of Chemical Formula 3 containing the crosslinkable functional group among l, m, and n is more than 1000, the degree of crosslinking is excessively increased, the mobility of the polymer chain may decrease and the ionic conductivity of the electrolyte may decrease.

As used herein, “hydroxy group” refers to —OH group.

As used herein, “carboxyl group” refers to —COOH group.

As used herein, “isocyanate group” refers to —N═C═O group.

As used herein, “nitro group” refers to —NO₂ group.

As used herein, “cyano group” refers to —CN group.

As used herein, “amide group” refers to —C(═O)N R′R″, wherein R′ and R″ may each independently be hydrogen or a C1 to C5 alkyl group, or R′ and R″ together with the N atom to which they are attached may form a heterocycle having C4 to C8 atoms in the ring structure.

As used herein, “amine group” may be selected from the group consisting of a monoalkylamine group; a monoarylamine group; a monoheteroarylamine group; a dialkylamine group; a diarylamine group; a diheteroarylamine group; an alkylarylamine group; an alkylheteroarylamine group; and an arylheteroarylamine group, and the carbon number thereof is not particularly limited, but is preferably 1 to 30. Specific examples of the amine group include a methylamine group, a dimethylamine group, an ethylamine group, a diethylamine group, a phenylamine group, a naphthylamine group, a biphenylamine group, a dibiphenylamine group, an anthracenyl amine group, a 9-methyl-anthracenylamine group, a diphenylamine group, a phenylnaphthylamine group, a ditolylamine group, a phenyltolylamine group, a triphenylamine group, a biphenylnaphthylamine group, a phenylbiphenyl amine group, a biphenylfluorenylamine group, a phenyltriphenylenylamine group, a biphenyltriphenylenylamine group, and the like, but are not limited thereto. Further, “amino group” refers to —NH₂.

As used herein, “allyl group” refers to —CH₂—CH═CH₂ group.

The weight average molecular weight (Mw) of the copolymer containing Chemical Formulas 1 to 3 may be 100,000 g/mol to 2,000,000 g/mol, and specifically, it may be 100,000 g/mol or more, 200,000 g/mol or more, or 300,000 g/mol or more, and 1,600,000 g/mol or less, 1,800,000 g/mol or less, or 2,000,000 g/mol or less. If the weight average molecular weight (Mw) of the copolymer is less than 100,000 g/mol, the mechanical properties of the film capable of forming an electrolyte may not be satisfied. If the weight average molecular weight (Mw) of the copolymer is more than 2,000,000 g/mol, the solubility during preparation of the polymer solution decreases due to an increase in viscosity, and polymer film molding for preparing the electrolyte may become difficult. Further, the ionic conductivity of the electrolyte may decrease due to a decrease in chain mobility caused by an increase in crystallinity inside the film during the production of the polymer film. In particular, when the number of repetitions of the repeating unit containing a crosslinkable functional group among l, m, and n is more than 1000, the degree of crosslinking increases excessively, and the mobility of polymer chains decreases, which may lead to a decrease in the ionic conductivity of the electrolyte.

Further, the copolymer may be a random copolymer or a block copolymer.

Meanwhile, the electrolyte may include a ceramic compound. The ceramic compound has a lithium ion transfer ability to improve the conductivity of lithium ions, and preferably contains lithium atoms but does not store lithium, and has the function of transporting lithium ions, and can improve the ionic conductivity of the electrolyte.

Further, the ceramic compound may be included in a uniformly dispersed state in the internal space of the crosslinked polymer chains, in the polymer film formed by a crosslinking bond induced during drying in step (S4). The ceramic compounds are mixed together in the formation of the mixed solution, and can be uniformly dispersed without aggregation in the internal space between the crosslinked polymer chains. Such ceramic compounds can be advantageous in improving the mechanical strength and ionic conductivity of the electrolyte due to its uniform dispersion form.

Further, the ceramic compound may be in the form of particles. Due to the morphological characteristics of particles, they can be contained in a more uniformly dispersed state within the electrolyte. The particles of the ceramic compound may be spherical, and its diameter may be 100 nm to 1000 nm. If the diameter is less than 100 nm, the effect of non-crystallization due to the decrease in crystallinity of the polymer may be slight, and if the diameter is more than 1000 nm, dispersibility may decrease due to an increase of aggregation between particles, which may make it difficult to disperse uniformly.

The ceramic compound may be an oxide-based or phosphate-based compound, for example, an oxide-based solid electrolyte in the form of lithium metal oxide or lithium metal phosphate. More specifically, the ceramic compound may be at least one selected from the group consisting of garnet-type lithium-lanthanum-zirconium oxide(LLZO, Li₇La₃Zr₂O₁₂)-based compound, perovskite-type lithium-lanthanum-titanium oxide(LLTO, Li₃xLa_{2/3-x}TiO₃)-based compound, phosphate-based NASICON type lithium-aluminum-titanium phosphate(LATP, Li₁₊ₓAlₓTi₂₋ₓ(PO₄)₃)-based compound, lithium-aluminum-germanium phosphate(LAGP, Li_{1.5}Al_{0.5}Ge_{1.5}(PO₄)₃)-based compound, lithium-silicon-titanium phosphate(LSTP, LiSiO₂TiO₂(PO₄)₃)-based compound, and lithium-lanthanum-zirconium-titanium oxide (LLZTO)-based compound. More preferably, at least one oxide-based solid electrolyte selected from the group consisting of lithium-lanthanum-zirconium oxide(LLZO), lithium-silicon-titanium phosphate(LSTP), lithium-lanthanum-titanium oxide(LLTO), lithium-aluminum-titanium phosphate(LATP), lithium-aluminum-germanium phosphate(LAGP), and lithium-lanthanum-zirconium-titanium oxide(LLZTO) may be used.

The oxide-based solid electrolyte made of the oxide-based or phosphate-based compound generally has an ionic conductivity value of up to 10⁻⁴˜10⁻³ S/cm at room temperature, and has the advantage of being stable in a high voltage region, being stable in air, and thus being easy to synthesize and handle.

Therefore, the above-mentioned electrolyte may further include a ceramic compound to compensate for the drawbacks involved in the polymer-based solid electrolyte.

Further, the ceramic compound does not easily cause combustion or ignition phenomenon even under high temperature conditions of 400° C. or more, and thus is high in high-temperature stability. Therefore, when the electrolyte contains a ceramic compound, it is possible to improve not only the mechanical strength but also the high temperature stability and ionic conductivity of the electrolyte.

The ceramic compound may be included in an amount of 10 parts by weight to 100 parts by weight, or 10 parts by weight to 60 parts by weight, based on 100 parts by weight of the PEO-based copolymer containing a crosslinkable functional group.

If the ceramic compound is included in an excessively small amount, the effect of lowering the crystallinity of the polymer and making it amorphous due to the ceramic compound is reduced, so that the effect of increasing the ionic conductivity of the electrolyte is not significant, and the mechanical properties may also not meet the expected level due to the formation of the composite.

If the ceramic compound is included in an excessively large amount, the ceramic compound is not uniformly dispersed within the polymer, and a phenomenon occurs where the ceramic compound particles clump and aggregate with each other, so that an electrolyte with reduced ionic conductivity can be prepared.

In one embodiment of the disclosure, the lithium salt can be used as a raw material to form an electrolyte. The lithium salt is contained in a dissociated ionic state in the internal space between the polymer chains, and thus, can improve the ionic conductivity of the electrolyte. At least a part of the cations and/or anions dissociated from the lithium salt exist in a state bonded to the polymer chain, and may exhibit mobility during charging/discharging of the battery.

The lithium salt may include at least one selected from the group consisting of (CF₃SO₂)₂Nli(lithium bis(trifluoromethanesulphonyl)imide, LiTFSI), (FSO₂)₂NLi(lithium bis(fluorosulfonyl)imide, LiFSI), LiNO₃, LiOH, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, lithium chloroborane, lithium lower aliphatic carboxylate and lithium tetraphenyl borate.

Further, the lithium salt may be included in an amount of 25 to 45 parts by weight based on 100 parts by weight of the PEO-based copolymer containing the crosslinkable functional group. Specifically, it may be included in an amount of 25 parts by weight or more, 30 parts by weight or more, or 35 parts by weight or more, or 40 parts by weight or less, or 45 parts by weight or less. If the content of the lithium salt is less than 25 parts by weight, the ionic conductivity of the electrolyte may decrease, and if the content of the lithium salt exceeds 45 parts by weight, the mechanical strength may decrease.

The crosslinking agent may form a crosslinking bond with the crosslinkable functional group, wherein the crosslinking bond may be a hydrogen bond, a bond formed by Lewis acid-base interaction, an ionic bond, a coordination bond, or a bond formed by radical polymerization.

The crosslinking agent is not particularly limited as long as it is a polyfunctional crosslinking agent that can form a crosslinking bond with the crosslinkable functional group. For example, the crosslinking agent may be one or more multifunctional crosslinking agents, for example, a bifunctional or higher polyvalent compound, selected from the group consisting of trimethylolpropane trimethacrylate, poly(ethylene glycol) diacrylate, poly(ethylene glycol) dimethacrylate, ethylene glycol dimethylacrylate (hereinafter referred to as “EGDMA”), 1,3-diisopropenylbenzene(DIP), 1,4-diacryloyl piperazine, 2-(diethylamino)ethyl methacrylate, 2,6-bisacryloylamidopyridine, 3-(acryloyloxy)-2-hydroxypropyl methacrylate, 3,5-bis(acryloylamido)benzoic acid, 3-aminopropyltriethoxysilane, 3-isocyanatopropyltriethoxysilane, 3-methylacryloxypropyl trimethoxysilane, bis-(1-(tert-butylperoxy)-1-methylethyl)-benzene, dicumyl peroxide, dimethacrylate, divinylbenzene, ethylene glycol maleic rosinate acrylate, glycidylmethacrylate, hydroxyquinoline, i-phenyldiethoxysilane, maleic rosin glycol acrylate, methylene bisacrylamide, N,N′-1,4-phenylenediacrylamine, N,O-bisacryloyl-phenylalaninol, N,O-bismethacryloyl ethanolamine, pentaerythritol triacrylate, phenyltrimethoxy silane, tetramethoxysilane, tetramethylene, tetraethoxysilane, and triallyl isocyanurate.

Further, the crosslinking agent may be included in an amount of 1 to 30 parts by weight based on 100 parts by weight of the PEO-based copolymer containing the crosslinkable functional group. If the content of the crosslinking agent is less than 1 part by weight, crosslinking with the crosslinkable functional group may not be sufficiently achieved, and if the content of the crosslinking agent is more than 30 parts by weight, excessive crosslinking may occur and the mobility of the polymer chain decreases, which may lead to a decrease in ionic conductivity.

In one embodiment of the disclosure, the initiator may induce a radical polymerization reaction between the crosslinkable functional groups to form a crosslinking bond between the crosslinkable functional groups. The functional group that enables the radical polymerization reaction may be a functional group containing vinyl at the end, for example, an allyl group.

The initiator is not particularly limited as long as it is an initiator that can induce a radical polymerization reaction between the crosslinkable functional groups. For example, the initiator may include at least one selected from the group consisting of benzoyl peroxide, azobisisobutyronitrile, lauroyl peroxide, cumene hydroperoxide, diisopropylphenyl-hydroperoxide, tert-butyl hydroperoxide, p-methane hydroperoxide and 2,2′-azobis(2-methylpropionitrile).

The initiator may be used in an amount of 0.5 to 2 parts by weight based on 100 parts by weight of the PEO-based copolymer containing a crosslinkable functional group. When the initiator is used within the above range, it can make it possible to induce a radical polymerization reaction between crosslinkable functional groups and efficiently form a crosslinking bond.

Meanwhile, in step (S2), the substrate can be unwound using an unwinder and supplied to a transfer path.

The unwinder unwinds and supplies a substrate wound in a roll shape through a predetermined transfer path, and can unwind and supply the substrate by its own drive. Further, in step (S6), the substrate may be unwound and supplied by the driving force of a rewinder that winds the substrate having the electrolyte layer formed thereon.

Therefore, the preparation of the electrolyte according to one embodiment may be a roll-to-roll process.

Further, the substrate is not particularly limited as long as it can function as a support for the coating film, and may be in the form of a film. For example, the substrate may SUS (stainless use steel), polyethylene terephthalate film, polytetrafluoroethylene film, polyethylene film, polypropylene film, polybutene film, polybutadiene film, vinyl chloride copolymer film, polyurethane film, ethylene-vinylacetate film, ethylene-propylene copolymer film, ethylene-ethyl acrylate copolymer film, ethylene-methyl acrylate copolymer film or polyimide film.

Meanwhile, in step (S3), the mixed solution can be coated onto the substrate to form a coating film.

Further, the coating method is not particularly limited as long as it can form a coating film by coating the mixed solution onto the substrate. For example, the coating method may be bar coating, roll coating, spin coating, slit coating, die coating, blade coating, comma coating, slot die coating, lip coating, spray coating or solution casting.

In one specific example of the coating method, a solution casting method may be used. More specifically, the mixed solution prepared in step (S1) is placed in a mixer, then the mixer is located on the substrate and the mixed solution is continuously casted on the substrate supplied through a unidirectional transfer path, thereby form a coating film.

Further, in step (S4), the coating film formed on the substrate can be transferred to a drying section and dried to form a polymer film.

The drying method may use a hot air drying method of drying with hot air at a temperature within a certain range, but is not limited to these examples. Any method can be used as long as the coating film on the substrate having the coating film formed thereon can be dried.

Specifically, the drying may be performed at 50° C. to 250° C., and specifically, the drying temperature may be 50° C. or more, 70° C. or more, or 90° C. or more, and 120° C. or less, 150° C. or less, 200° C. or less, or 250° C. or less. If the drying temperature is less than 50° C., the coating film formed by coating the mixed solution onto the substrate is not sufficiently dried, and may flow down as a liquid phase, and if the drying temperature is more than 250° C., the coating film coated onto the substrate may be damaged or bubbles may be generated, so that a smooth coating film may not be formed.

Alternatively, the drying can comprise a primary drying and a secondary drying. Through the primary drying, a part of the solvent contained in the coating film may be removed to form a film, and through the secondary drying, a crosslinking bond between crosslinkable functional groups induced by the initiator and/or a crosslinking bond between the crosslinkable functional group and the crosslinking agent may be formed.

The primary drying may be performed at room temperature for 5 to 20 hours, and the secondary drying may be performed at 50° C. to 250° C. as described above. When the drying process is performed by primary drying and secondary drying in this way, a film with a uniform shape is formed, and the internal crosslinking bond can be better formed.

In addition, the drying section is not limited to one stage. If the drying path is long, the drying section may be formed in multiple stages to improve drying efficiency. For example, a drying section of three or more stages may be formed.

As a result of the drying process, the polymer film undergoes a crosslinking reaction, and may include polymer chains including a crosslinking bond. The crosslinking bond may include a crosslinking bond between crosslinkable functional groups and/or a crosslinking bond between a crosslinkable functional group and a crosslinking agent. For example, at least a part of the crosslinkable functional groups may form a crosslinking bond with each other via the crosslinking agent, thereby forming the above-mentioned three-dimensional network structure.

The crosslinking bond between crosslinkable functional groups may be a urethane crosslinked bond, an ester crosslinked bond, a hydrogen bond, a bond formed from a radical polymerization reaction by a vinyl group at the end of an allyl group (—CH₂—CH═CH₂), and the like, but is not limited to these examples.

Further, a crosslinking bond between the crosslinkable functional group and the crosslinking agent may be a hydrogen bond, a bond formed by a Lewis acid-base interaction, an ionic bond, a coordination bond, or a bond formed by radical polymerization.

The ceramic compound may be uniformly dispersed in the internal space of the crosslinked polymer chain, for example, within a three-dimensional network structure, and the lithium salt may be dissociated and contained in an ionic state.

Meanwhile, in step (S5), the polymer film may be transferred to a vapor deposition section and a polar compound may be vapor-deposited to prepare an electrolyte.

The vapor deposition naturally evaporates the polar compound at room temperature or evaporates it by heating, so that the gas molecules of the polar compound can be bonded to the polymer chains inside the polymer film, or the gas molecules of the polar compound can be included in the internal space of the polymer chains.

The polar compound is uniformly diffused on the surface and/or inside of the polymer by leaving the polar compound at room temperature or by vapor-depositing the compound through heating in this way, so that the gas molecules of the polar compound can be bonded to the polymer chain, or can be included in a uniformly dispersed form in the internal space of the polymer chain.

When the polar compound is left at room temperature during the vapor deposition, a trace amount of a polar compound with a low boiling point can penetrate into the solid electrolyte at room temperature, thereby effectively inducing a change in the conformation of the polymer chains crosslinked within the polymer.

Further, when heating a polar compound during vapor deposition, the vapor deposition rate can be improved. At this time, the heating temperature is not particularly limited as long as it is a temperature at which the polar compound can undergo a phase change to vapor, and may be, for example, 30° C. to 80° C. A general PEO is melted at 60° C., but when a PEO-based copolymer modified with the crosslinkable functional group forms a crosslinked structure, it is improved in heat resistance and can withstand up to 80° C., thereby further increasing a vapor deposition rate. Further, the heating method is not limited as long as it is a method that can supply energy to generate steam. For example, a direct heating method using a burner or stove, or an indirect heating method using a heater or steam pipe, etc. can be used, but the method is not limited only to these examples.

During the heating, when the heating temperature is too high, there are the drawbacks that the compound may boil at a boiling point or higher of the polar compound, or deformation of the polymer may be induced, and it is difficult to control the evaporation rate of the polar compound during vapor deposition. Therefore, in order to perform vapor deposition with a trace amount of polar compound, it may be desirable to perform vapor deposition at a heating temperature in the appropriate range as specified above.

A polymer solid electrolyte comprising a polar compound which is a gaseous molecule of the polar compound bonded to the chains of crosslinked polymers via vapor deposition or contained in the internal spaces between polymer chains, as described above, can be prepared.

The polar compound may be bonded to a surface of or dispersed between polymer chains of the PEO-based copolymer by adsorbing a gas molecule of the polar compound to the polymer during vapor deposition, and then diffusing it into the polymer chain. Specifically, the polar compound is either bonded to the surface of the polymer chains, or contained in a dispersed form in internal space between the polymer chains.

The polar compound is either bonded to the polymer chain, or contained in a dispersed form in the internal space between the polymer chains, thereby capable of improving the ionic conductivity of the final prepared electrolyte.

Such an electrolyte does not substantially contain a solvent or electrolyte solution in a liquid state, but contains a trace amount of a polar compound included or bonded in a gaseous state by the vapor deposition. Such an electrolyte can be confirmed from the fact that no liquid components are observed on the surface of the electrolyte layer, for example, when the electrolyte layer containing the same is separated from the all-solid-state battery and then observed with the naked eye, an electron microscope or the like. Unlike the same, when a polar compound or electrolyte solution in a liquid state is injected into the electrolyte, a liquid component or a component showing wettability can be observed on the surface of the electrolyte layer. In addition, the electrolyte in which the polar compound is vapor-deposited and contained in a gaseous state exhibits significantly higher ionic conductivity than when a polar compound or electrolyte solution in a liquid state is injected. Even through such comparison of ionic conductivity, and the like, an electrolyte in which the polar compound is vapor-deposited and contained in a gaseous state can be confirmed.

Specifically, a polar compound bonded to the polymer chain or contained in the internal space between the polymer chains can function as a plasticizer and plasticize the polymer. The plasticized polymer may have an increased amorphous region in the inside thereof, which can improve the mobility of the polymer chain. As the mobility of the polymer chain improves, the ion hopping effect inside the polymer increases, and the ionic conductivity of the electrolyte can be improved.

Further, the polar compound can function as an intermediate for smooth ion transfer through ion hopping. Since the affinity between lithium ions and polar compounds is stronger than the affinity between lithium ions and the ether oxygen of the PEO-based copolymer, the transfer of lithium ions may be faster and easier within the polymer to which the polar compound is adsorbed. That is, as the polar compound flows in the inside of the polymer, the cation solvation effect of lithium ions increases to improve ion mobility, and thereby, the ionic conductivity of the polymer solid electrolyte can be improved.

Further, the polar compound may include at least one selected from the group consisting of a carbonate-based compound and a sulfonyl-based compound.

Specifically, the polar compound may include at least one selected from the group consisting of ethyl methyl carbonate(EMC), dimethyl carbonate(DMC), diethyl carbonate(DEC), ethylene carbonate(EC), propylene carbonate(PC), vinylene carbonate(VC) and Sulfolane, or a combination thereof.

The content of the polar compound may include 0.1% by weight or more and less than 10% by weight, based on the total weight of the electrolyte. For example, the content of the polar compound may be 0.1% by weight or more, 1% by weight or more, and 2% by weight or less, or 8% by weight or less, or 9% by weight or less, or less than 10% by weight. When the content of the polar compound is less than 0.1% by weight, it is difficult to induce a change in the chain conformation inside the polymer, and thus, the ionic conductivity of the electrolyte is not improved. When the content of the polar compound is 10% by weight or more, the electrolyte has a large liquid content and has the properties of a semi-solid battery. Further, the mechanical strength of the electrolyte may decrease due to gelation of the polymer.

Additionally, in step (S6), the substrate including the electrolyte layer can be wound and recovered using a rewinder.

The rewinder can wind and recover the substrate including the electrolyte layer into a roll shape, and can wind the substrate including the electrolyte layer by its own drive.

The substrate containing the recovered electrolyte layer can be used by itself, or the electrolyte may be used in the form of a free-standing film by further performing the step of separating the electrolyte layer from the substrate.

The free-standing film refers to a film that can maintain its film form by itself at room temperature and pressure without a separate support, that is, without a substrate.

In the preparation method of the above-described one embodiment, steps (S1) to (S6) can be performed continuously, so that the electrolyte can be prepared by a continuous process.

### Electrolyte

The electrolyte prepared according to the above-mentioned one embodiment comprises: a polymer containing a PEO (polyethylene oxide)-based copolymer containing a crosslinkable functional group; a ceramic compound; and a polar compound, wherein at least a part of the crosslinkable functional groups of the copolymer form a crosslinking bond with each other, so that the polymer forms a three-dimensional network structure, and wherein the polar compound in a gaseous state is contained in the three-dimensional network structure or may have a structure bonded on the polymer chain.

In the electrolyte, the three-dimensional network structure is a structure including a three-dimensional frame and an internal space formed by an upper frame, the frame includes a polymer chain containing a crosslinking bond formed by the crosslinkable functional group, and the internal space may contain a ceramic compound or a polar compound in a gaseous state through vapor deposition.

The crosslinking bond formed by the crosslinkable functional group constituting the frame may include a crosslinking bond between the crosslinkable functional groups and/or a crosslinking bond between the crosslinkable functional groups and the crosslinking agent.

As the ceramic compound is contained in a dispersed form in the internal space of the three-dimensional network structure, uniform dispersion of the ceramic compound is possible. Due to the morphological characteristics in which the ceramic compound is uniformly dispersed, the mechanical strength and ionic conductivity of the electrolyte can be further improved.

Further, a polar compound in a gaseous state may be bonded to the polymer chain, or a polar compound in a gaseous state may be contained in the internal space of the polymer chain. At this time, the method by which the polar compound is bonded to the polymer chain is not particularly limited as long as the polar compound is fixed to the polymer chain. In other words, the bond may mean including both physicochemical and chemical bonds.

In addition, the form, structure, types and contents of the components of the electrolyte are the same as described above.

### All-Solid-State Battery

A further embodiment of the disclosure also relates to an all-solid-state battery comprising the above electrolyte, wherein the all-solid-state battery includes a negative electrode, a positive electrode, and an electrolyte interposed between the negative electrode and the positive electrode, and the electrolyte is prepared according to the above-mentioned one embodiment.

Specifically, the electrolyte has a three-dimensional network structure of the polymer chain as described above, wherein a ceramic compound is uniformly contained in the inner space of the polymer chain, and a polar compound is bonded to the polymer chain or contained in the internal space of the polymer chain through a vapor deposition process, thereby improving the mechanical properties and ionic conductivity are improved, which can be suitable as an electrolyte for an all-solid-state battery.

Meanwhile, the positive electrode included in the all-solid-state battery includes a positive electrode active material layer, wherein the positive electrode active material layer may be formed on one surface of the positive electrode current collector.

The positive electrode active material layer includes a positive electrode active material, a binder, and a conductive material.

Further, the positive electrode active material is not particularly limited as long as it is a material capable of reversibly absorbing and desorbing lithium ions, and examples thereof may be a layered compound, such as lithium cobalt oxide(LiCoO₂), lithium nickel oxide(LiNiO₂), Li[NixCoyMnzMv]O₂ (where M is any one selected from the group consisting of Al, Ga, and In, or two or more elements thereof; and 0.3≤x<1.0, 0≤y, z≤0.5, 0≤v≤0.1, and x+y+z+v=1), Li(LiaMb−a−b′M′b′)O_{2-c}A_{c} (where 0≤a≤0.2, 0.6≤b≤1, 0≤b′≤0.2, and 0≤c≤0.2; M includes Mn and at least one selected from the group consisting of Ni, Co, Fe, Cr, V, Cu, Zn, and Ti; M is at least one selected from the group consisting of Al, Mg, and B; and A is at least one selected from the group consisting of P, F, S, and N), or a compound substituted with at least one transition metal; lithium manganese oxides such as the chemical formula Li_{1+y}Mn_{2-y}O₄ (where y ranges from 0 to 0.33), LiMnO₃, LiMn₂O₃, and LiMnO₂; lithium copper oxide (Li₂CuO₂); vanadium oxides such as LiV₃O₈, LiFe₃O₄, V₂O₅, and Cu₂V₂O₇; Ni-site type lithium nickel oxide expressed by the chemical formula LiNi_{1-y}M_{y}O₂ (where M is Co, Mn, Al, Cu, Fe, Mg, B, or Ga, and y ranges from 0.01 to 0.3); lithium manganese complex oxide expressed by the chemical formula LiMn_{2-y}M_{y}O₂ (where M is Co, Ni, Fe, Cr, Zn, or Ta, and y ranges from 0.01 to 0.1) or Li₂Mn₃MO₈ (where M is Fe, Co, Ni, Cu, or Zn); LiMn₂O₄ having a part of Li being substituted with alkaline earth metal ions; a disulfide compound; and a complex oxide formed of Fe₂(MoO₄)₃, but are not limited thereto.

Further, the positive electrode active material may be included in an amount of 40 to 80% by weight based on the total weight of the positive electrode active material layer. Specifically, the content of the positive electrode active material may be 40% by weight or more or 50% by weight or more, and 70% by weight or less or 80% by weight or less. If the content of the positive electrode active material is less than 40% by weight, the connectivity between positive electrode active materials may be insufficient, and if the content of the positive electrode active material is more than 80% by weight, the mass transfer resistance may increase.

Further, the binder is a component assisting in binding between the positive electrode active material and the conductive material, and in binding with the current collector. The binder may include at least one selected from the group consisting of styrene-butadiene rubber, acrylic styrene-butadiene rubber, acrylonitrile copolymer, acrylonitrile-butadiene rubber, nitrile butadiene rubber, acrylonitrile-styrene-butadiene copolymer, acrylic rubber, butyl rubber, fluorine rubber, polytetrafluoroethylene, polyethylene, polypropylene, ethylene/propylene copolymer, polybutadiene, polyethylene oxide, chlorosulfonated polyethylene, polyvinylpyrrolidone, polyvinylpyridine, polyvinyl alcohol, polyvinyl acetate, polyepicchlorohydrin, polyphosphazene, polyacrylonitrile, polystyrene, latex, acrylic resin, phenolic resin, epoxy resin, carboxymethylcellulose, hydroxypropyl cellulose, cellulose acetate, cellulose acetate butyrate, cellulose acetate propionate, cyanoethyl cellulose, cyanoethyl sucrose, polyester, polyamide, polyether, polyimide, polycarboxylate, polycarboxylic acid, polyacrylic acid, polyacrylate, lithium polyacrylate, polymethacrylic acid, polymethacrylate, polyacrylamide, polyurethane, polyvinylidene fluoride and poly(vinylidene fluoride)-hexafluoropropene. Preferably, the binder may include at least one selected from the group consisting of styrene-butadiene rubber, polytetrafluoroethylene, carboxymethylcellulose, polyacrylic acid, lithium polyacrylate and polyvinylidene fluoride.

Further, the binder may be included in an amount of 1% by weight to 30% by weight based on the total weight of the positive electrode active material layer. Specifically, the content of the binder may be 1% by weight or more or 3% by weight or more, and 15% by weight or less or 30% by weight or less. If the content of the binder is less than 1% by weight, the adhesion between the positive electrode active material and the positive electrode current collector may decrease, and if the content of the binder is more than 30% by weight, the adhesion is improved, but the content of the positive electrode active material is reduced accordingly, which may lower battery capacity.

Further, the conductive material is not particularly limited as long as it does not cause side reactions in the internal environment of the battery and does not cause chemical changes in the battery but has excellent electrical conductivity. The conductive material may typically be graphite or electrically conductive carbon, and may be, for example, but is not limited to, one selected from the group consisting of graphite such as natural graphite or artificial graphite; carbon black such as carbon black, acetylene black, Ketjen black, Denka black, thermal black, channel black, furnace black, lamp black, and summer black; carbon-based materials whose crystal structure is graphene or graphite; electrically conductive fibers such as carbon fibers and metal fibers; carbon fluoride; metal powders such as aluminum and nickel powder; electrically conductive whiskers such as zinc oxide and potassium titanate; electrically conductive oxides such as titanium oxide; electrically conductive polymers such as polyphenylene derivatives; and a mixture of two or more thereof.

The conductive material may typically be included in an amount of 0.5% to 30% by weight based on the total weight of the positive electrode active material layer. Specifically, the content of the conductive material may be 0.5% by weight or more or 1% by weight or more, and 20% by weight or less, or 30% by weight or less. If the content of the conductive material is too low, that is, less than 0.5% by weight, it is difficult to obtain an effect on the improvement of the electrical conductivity, or the electrochemical characteristics of the battery may be deteriorated. If the content of the conductive material too high, that is, more than 30% by weight, the amount of positive electrode active material is relatively small and thus capacity and energy density may be lowered. The method of incorporating the conductive material into the positive electrode is not particularly limited, and conventional methods known in the related art such as coating on the positive electrode active material can be used.

Further, the positive electrode current collector supports the positive electrode active material layer and plays the role of transmitting electrons between the external conductor and the positive electrode active material layer.

The positive electrode current collector is not particularly limited so long as it does not cause chemical changes in the all-solid-state battery and has conductivity. For example, the positive electrode current collector may be made of copper, stainless steel, aluminum, nickel, titanium, palladium, fired carbon, copper or stainless steel that is surface-treated with one of carbon, nickel, titanium, silver, or the like, an aluminum-cadmium alloy, or the like.

The positive electrode current collector may have a fine protrusion and depression structure layer or may adopt a three-dimensional porous structure in order to improve bonding strength with the positive electrode active material layer. Thereby, the positive electrode current collector may be used in any of various forms including a film, a sheet, a foil, a mesh, a net, a porous body, a foaming body, and a non-woven fabric structure.

The positive electrode as described above can be prepared according to conventional methods. Specifically, the positive electrode can be prepared by a process in which a composition for forming a positive electrode active material layer, which is prepared by mixing a positive electrode active material, a conductive material, and a binder in an organic solvent, is coated and dried on a positive electrode current collector, and optionally, compression molding is performed on the current collector to improve the electrode density. At this time, as the organic solvent, a solvent that can uniformly disperse the positive electrode active material, binder, and conductive material, and that evaporates easily, is preferably used. Specifically, acetonitrile, methanol, ethanol, tetrahydrofuran, water, isopropyl alcohol, and the like can be mentioned.

On the other hand, the negative electrode contained in the all-solid-state battery includes a negative electrode active material layer, and the negative electrode active material layer may be formed on one surface of the negative electrode current collector.

The negative electrode active material may include a material capable of reversible intercalation and deintercalation of lithium (L⁺), a material that can react with lithium ions to reversibly form a lithium-containing compound, lithium metal or lithium alloy.

The material capable of reversible intercalation and deintercalation of lithium (L⁺) may be, for example, a crystalline carbon, an amorphous carbon, or a mixture thereof. The material that can react with lithium ions (Li⁺) to reversibly form a lithium-containing compound may be, for example, tin oxide, titanium nitrate, or silicon. The lithium alloy may be, for example, an alloy of metals selected from the group consisting of lithium (Li) and sodium (Na), potassium (K), rubidium (Rb), cesium (Cs), francium (Fr), beryllium (Be), magnesium (Mg), calcium (Ca), strontium (Sr), barium (Ba), radium (Ra), aluminum (Al) and tin (Sn).

Preferably, the negative electrode active material may be lithium metal, and specifically, may be in the form of a lithium metal thin film or lithium metal powder.

The negative electrode active material may be included in an amount of 40 to 80% by weight based on the total weight of the negative electrode active material layer. Specifically, the content of the negative electrode active material may be 40% by weight or more or 50% by weight or more, and 70% by weight or less or 80% by weight or less. If the content of the negative electrode active material is less than 40% by weight, the connectivity between the wet negative electrode active material layer and the dry negative electrode active material layer may become insufficient, and if the content of the negative electrode active material is more than 80% by weight, the mass transfer resistance may increase.

Further, the binder is the same as described above for the positive electrode active material layer.

Further, the conductive material is the same as described above for the positive electrode active material layer.

Further, the negative electrode current collector is not particularly limited so long as it does not cause chemical changes in the corresponding battery and has conductivity. For example, the negative electrode current collector may be made of copper, stainless steel, aluminum, nickel, titanium, fired carbon, copper or stainless steel that is surface-treated with one of carbon, nickel, titanium, silver, or the like, an aluminum-cadmium alloy, or the like. Further, similar to the positive electrode current collector, the negative electrode current collector may be used in various forms such as a film, a sheet, a foil, a net, a porous body, a foaming body, and a non-woven fabric structure, which fine protrusions and depressions are formed on a surface thereof.

The preparation method of the negative electrode is not particularly limited, and it can be prepared by forming a negative electrode active material layer on a negative electrode current collector using a layer or film forming method commonly used in the art. For example, methods such as compression, coating, and deposition can be used. Further, the negative electrode of the present disclosure also includes a case in which a battery is assembled in a state where a lithium thin film does not exist on the negative electrode current collector, and then a metallic lithium thin film is formed on a metal plate through initial charging.

According to still another embodiment, there are provided a battery module including the all-solid state battery as a unit cell, a battery pack including the battery module, and a device including the battery pack as a power source.

At this time, particular examples of the device may include, but are not limited to: power tools driven by an electric motor; electric cars, including electric vehicles (EV), hybrid electric vehicles (HEV), plug-in hybrid electric vehicles (PHEV), or the like; electric carts, including electric bikes (E-bikes) and electric scooters (E-scooters); electric golf carts; electric power storage systems; or the like.

Preferred examples will be presented hereinafter so that the present disclosure can be understood with ease. However, the following examples are for illustrative purposes only and the scope of the invention is not limited thereto.

In the following Examples and Comparative Examples, an electrolyte containing a polymer containing a copolymer and an organic solvent was prepared as shown in Table 1 below.

### Example

### Example 1: Preparation of Electrolyte

### Step 1) Preparation of Mixed Solution

A polyethylene oxide (PEO)-based copolymer of the following Chemical Formula 1a was prepared:

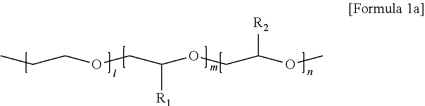

wherein, in Chemical Formula 1a, R₁ is —CH₂—O—(CH₂—CH₂—O)ₖ—CH₃, R₂ is —CH₂—O—CH₂—CH═CH₂, k is 2, the ratio of l:m:n is 85:13:2, and the weight average molecular weight (Mw) of the copolymer is about 2,000,000 g/mol.

The copolymer of Chemical Formula 1a has an allyl group bonded through a methylene oxide linker as a crosslinkable functional group.

The polyethylene oxide copolymer was mixed with acetonitrile as a solvent, trimethylolpropane trimethacrylate as a crosslinking agent, benzoyl peroxide as an initiator, LiTFSI as a lithium salt, and LSTP as a ceramic compound were mixed to prepare a mixed solution of the polymer and the ceramic compound, which was then stirred using a magnetic bar for 24 hours. At this time, the mixed solution of the polyethylene oxide copolymer and the ceramic compound was composed of 20 parts by weight of trimethylolpropane trimethacrylate as a crosslinking agent, 1 part by weight of benzoyl peroxide as an initiator, 36 parts by weight of LiTFSI as a lithium salt, and 40 parts by weight of LSTP as a ceramic compound based on 100 parts by weight of the polyethylene oxide copolymer, wherein an acetonitrile solvent was used so that the concentration of polyethylene oxide copolymer, which is a polymer contained in the mixed solution, was 11.1 wt. %, and the concentration of the polymer polyethylene oxide copolymer and ceramic compound was 14.9 wt. %.

### Step 2) Supply of Substrate

SUS foil as a substrate film was supplied through a unidirectional transfer path using an unwinder.

### Step 3) Formation of Coating Film

The mixed solution was placed in a mixer, and then coated by a solution casting method on SUS foil, which is a substrate film supplied through a unidirectional transfer path by an unwinder, to form a coating film.

### Step 4) Formation of Polymer Film

The coating film formed on the substrate film supplied through the unidirectional transfer path using the unwinder was transferred to the drying section, primarily dried at room temperature for 12 hours, and then secondarily dried at 100° C. for 3 hours to prepare a polymer film with a thickness of 200 μm.

Step 5) Preparation of Electrolyte after Vapor Deposition

The polymer film was transported to the vapor deposition section, and subjected to vapor deposition.

In the vapor deposition, the lower part of the chamber in the vapor deposition section was filled with EMC (ethylmethyl carbonate), and then naturally evaporated at room temperature for 72 hours, and the EMC vapor was allowed to flow into the inside of the polymer film that was transferred so as to be located at upper part of the chamber. Thereby, the EMC molecules were bonded to the polymer chain inside the polymer film or deposited so as to be located in the internal space of the polymer chain to prepare an electrolyte layer.

Step 6) Preparation of Electrolyte after Vapor Deposition

The substrate film containing the prepared electrolyte layer was wound and recovered using a rewinder. Then, the substrate film was peeled off to prepare an electrolyte in the form of a free-standing film.

### Comparative Example

### Comparative Example 1: Electrolyte Containing Only Modified PEO (Containing No Liquid)

An electrolyte was prepared in the same manner as in Example 1, except that the step of vapor-depositing EMC, which is step 5) of Example 1, was not performed.

### Comparative Example 2: Electrolyte Containing Modified PEO+Large Amount of Liquid

An electrolyte was prepared in the same manner as in Example 1, except that the EMC was directly injected into the electrolyte prepared in step 1) of Example 1.

### Comparative Example 3: Unmodified PEO+Ceramic Compound+Polar Compound-Deposited Electrolyte

An electrolyte was prepared in the same manner as in Example 1, except that polyethylene oxide (PEO) homopolymer (weight average molecular weight: about 4,000,000 g/mol) unsubstituted with crosslinkable functional groups was used, and no crosslinking agent or initiator was added.

### Comparative Example 4: Modified PEO+Polar Compound-Deposited Electrolyte

An electrolyte was prepared in the same manner as in Example 1, except that no ceramic compound was added.

### Experimental Example

### Experimental Example 1: Measurement of Content of Polar Compound

The content of the polar compound could be measured by using a balance and monitoring the weight of the liquid phase evaporated over time while heating the electrolyte sample. For example, it can be measured by monitoring the weight of the liquid phase that evaporates over time while heating the sample at a temperature of 55 to 70° C., or at a temperature of 60° C. using a heated electronic balance (AND MS-70). When the amount of polar compounds evaporated over time reached saturation, the saturation amount at that time was considered the total amount of polar compounds contained within the electrolyte. In Examples and Comparative Examples, the polar compound may be ethylmethyl carbonate (EMC).

### Experimental Example 2: Measurement of Ionic Conductivity of Electrolyte

To measure the ionic conductivity of the electrolyte prepared in Examples and Comparative Examples, the electrolyte was formed on the lower substrate of a coin cell with a size of 1.7671 cm², and then a coin cell for ionic conductivity measurement was fabricated using SUS as a blocking electrode.

Resistance was measured using an electrochemical impedance spectrometer (EIS, VM3, Bio Logic Science Instrument) at 25° C. with an amplitude of 10 mV and a scan range of 1 Hz to 0.1 MHz, and then the ionic conductivity of the electrolyte was calculated using the following Equation 1.

$${σ}_{i} = \frac{L}{RA} \qquad [ Equations 1 ]$$

Wherein, in Equation 1, σi is the ionic conductivity (S/cm) of the electrolyte, R is the resistance (Ω) of the electrolyte measured with the electrochemical impedance spectrometer, L is the thickness (μm) of the electrolyte, and A means the area (cm²) of the electrolyte. The electrolyte sample used had L=200 μm and A=1.7671 cm².

Table 1 below shows the measurement results of the content of the EMC vapor-deposited (or included) in the electrolyte and the ionic conductivity.

TABLE 1

| | EMC content (wt. %) based on the total | |
|---|---|---|
| | weight of electrolyte | Ion conductivity (S/cm) |
| Example 1 | 1.2 | 1.3 × 10⁻³ |
| Comparative | — | 1.4 × 10⁻⁴ |
| Example 1 | | |
| Comparative | 12 | 3.8 × 10⁻⁴ |
| Example 2 | | |
| Comparative | 1.5 | Not measurable |
| Example 3 | | |
| Comparative | 1.2 | 5.1 × 10⁻⁴ |
| Example 4 | | |

Referring to Table 1, it was confirmed that the continuously prepared electrolyte of Example exhibited excellent ionic conductivity compared to the electrolyte of Comparative Examples.

1. A method for preparing an electrolyte, the method comprising:
(S1) preparing a solution comprising a polyethylene oxide (PEO) based copolymer having crosslinkable functional groups and a ceramic compound;
(S2) supplying a substrate to a transfer path by unwinding the same using an unwinder;
(S3) forming a coating film by coating the solution on the substrate;
(S4) forming a polymer film by transferring the substrate having the coating film formed thereon to a drying section and drying the same;
(S5) forming an electrolyte layer by transferring the substrate having the polymer film to a vapor deposition section and vapor-depositing a polar compound on the polymer film; and
(S6) winding and recovering the substrate including the electrolyte layer formed thereon using a rewinder.

2. The method according to claim 1, wherein the solution of the step (S1) further comprises one or more selected from the group consisting of a lithium salt, a crosslinking agent, and an initiator.

3. The method according to claim 1, wherein the solution contains 10 to 100 parts by weight of the ceramic compound based on 100 parts by weight of the PEO based copolymer.

4. The method according to claim 1, wherein in the vapor-depositing of the step (S5), the polar compound is evaporated at room temperature or evaporated by heating such that gas molecules of the polar compound are bonded to a surface of or dispersed between polymer chains of the PEO-based copolymer.

5. The method according to claim 1, wherein the crosslinkable functional groups are bonded to a main chain of the PEO-based copolymer via a direct bond or a linker having 0 to 10 carbon atoms, and
wherein the crosslinkable functional groups are selected from the group consisting of a hydroxyl group, a carboxyl group, an isocyanate group, a nitro group, a cyano group, an amine group, an amide group, an epoxy group, and an allyl group.

6. The method according to claim 1, wherein the PEO based copolymer comprises repeating units of the following Chemical Formulas 1 to 3: 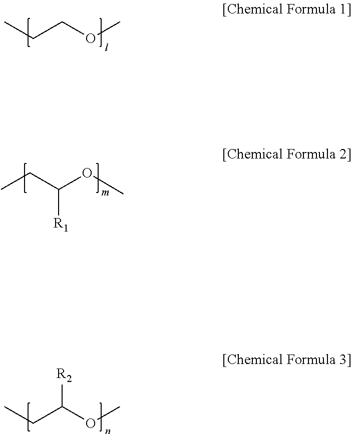
wherein, in Chemical Formulas 1 to 3,
R₁ is —CH₂—O—(CH₂—CH₂—O)ₖ—R₃, k is 0 to 20, R₃ is an alkyl group having 1 to 5 carbon atoms,
R₂ is a group in which one or more crosslinkable functional groups selected from the group consisting of a hydroxyl group, a carboxyl group, an isocyanate group, a nitro group, a cyano group, an amine group, an amide group, an epoxy group, and an allyl group are bonded to a main chain of the PEO-based copolymer via a direct bond or a linker having 0 to 10 carbon atoms, and
l, m, and n are number of repetitions of the repeating unit, wherein l and n are each independently an integer of 1 to 1000, and m is an integer of 0 to 1000.

7. The method according to claim 1,
a content of the polar compound is 0.1% by weight or more and less than 10% by weight based on the total weight of the electrolyte.

8. The method according to claim 1, wherein the polar compound comprises one or more selected from the group consisting of a carbonate-based compound and a sulfonyl-based compound.

9. The method according to claim 1, wherein the polar compound comprises one or more selected from the group consisting of ethyl methyl carbonate(EMC), dimethyl carbonate(DMC), diethyl carbonate(DEC), ethylene carbonate(EC), propylene carbonate(PC), vinylene carbonate(VC), and Sulfolane.

10. The method according to claim 1, wherein the ceramic compound comprises one or more selected from the group consisting of a lithium-lanthanum-zirconium oxide(LLZO)-based compound, a lithium-silicon-titanium phosphate(LSTP)-based compound, a lithium-lanthanum-titanium oxide(LLTO)-based compound, a lithium-aluminum-titanium phosphate(LATP)-based compound, a lithium-aluminum-germanium phosphate(LAGP)-based compound, and a lithium-lanthanum-zirconium-titanium oxide(LLZTO)-based compound.

11. The method according to claim 1, wherein the steps (S1) to (S6) are performed continuously.

12. An electrolyte prepared by the method of claim 1.

13. The electrolyte according to claim 12, wherein the electrolyte comprises the PEO-based copolymer containing a crosslinkable functional group; the ceramic compound; and a polar compound,
wherein at least some of the crosslinkable functional groups of polymer chains of the PEO-based copolymer form a crosslinking bond with each other such that the PEO-based copolymer forms a three-dimensional network structure, and
wherein the polar compound is contained in the three-dimensional network structure.
